(19) United States
(12) Patent Application Publication
(10) Pub. No.: US 2026/0326698 A1
(43) Pub. Date: Oct. 22, 2026

(54) VEHICLE BUMPER WITH SENSOR SUPPORT AND VEHICLE EQUIPPED THEREWITH

(71) Applicant: FLEXIS, BOULOGNE-BILLANCOURT (FR)

(72) Inventors: Jean-Louis AESCHLIMANN, GUYANCOURT (FR); Regis MOGNER, VILLIERS SAINT-FREDERIC (FR)

(21) Appl. No.: 19/650,882

(22) Filed: Apr. 17, 2026

(30) Foreign Application Priority Data
Apr. 22, 2025 (FR) FR2504251

(51) Int. Cl. B60R 19/48

(52) U.S. Cl. CPC B60R 19/483

(57) ABSTRACT

A bumper of a vehicle includes a bumper wall provided to be positioned in front of a crossmember, and at least one sensor mounted on a sensor support, wherein the sensor support includes a receptacle which is provided to receive the sensor in such a manner that the detection direction of the sensor passes through an opening arranged in the bumper wall, the sensor being fitted with a connection cable, characterized in that the sensor support includes a plate which is arranged on the rear face of the bumper wall, the plate being fitted, on its rear face, with at least one spacer provided to be interposed between the rear face of the bumper wall and a front face of the crossmember.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a vehicle bumper equipped with at least one sensor and to a vehicle equipped therewith.

### BACKGROUND

The design of a vehicle generally provides that its front or rear bumper can be subjected to small impacts without notable deterioration of the functions present on the bumper. “Small impacts” here means impacts sustained at a speed less than 6 km/h.

It is known to equip a bumper with sensors, in particular proximity sensors, or parking sensors, which allow to guide the driver of the vehicle during a parking maneuver or other maneuver. The vehicle assembly method generally requires equipping the bumper with the sensors and their cables before mounting the bumper on the body of the vehicle.

In the case of commercial vehicles, the bumper can be mounted at the front of a crossmember without an energy absorber being provided between the crossmember and a bumper wall. In addition, the crossmember can include a cut-out to receive part of a sensor, which creates relatively sharp edges. This results in a significant risk of crushing or severing the cables connected to the sensors when the bumper sustains an impact.

### SUMMARY

One aim of the present disclosure is to propose a solution to reduce the risks of crushing or severing the connection cables associated with the sensors present on the bumper.

To this end, the present disclosure has as its object a vehicle bumper including a bumper wall provided to be positioned in front of a crossmember of the vehicle, and at least one sensor mounted on a sensor support that is fixed on a rear face of the bumper wall, in which the sensor support includes a receptacle which is provided to receive the sensor such that the detection direction of the sensor passes through an opening arranged in the bumper wall, the sensor being fitted with a connection cable, characterized in that the sensor support includes a plate which is arranged on the rear face of the bumper wall, the plate being fitted, on its rear face, with at least one spacer intended to be interposed between the rear face of the bumper wall and a front face of the crossmember, so in such a manner as to protect the connection cable against crushing between the bumper wall and the front face of the crossmember, in the event of a front impact against the bumper wall.

The bumper according to the present disclosure allows to facilitate the mounting of the sensor on the bumper while protecting the sensor connection cables during small impacts sustained by the bumper. This is particularly advantageous for a commercial vehicle that includes, at the rear, a low loading sill requiring the rear bumper to be arranged as low as possible and close to a rear crossmember.

According to other advantageous aspects of the present disclosure, the bumper comprises one or more of the following features, taken alone or in any technically possible combination:
the plate extends generally in a plane substantially orthogonal to the detection direction of the sensor;
the plate includes at least one guide element able to retain the connection cable against the plate;
said at least one guide element includes an elastic tab which is arranged on the rear face of the plate and configured to press the connection cable against the rear face of the plate;
the at least one guide element is realized in one piece with the plate;
the plate includes a first section which extends according to a first direction transverse to the main detection axis of the sensor, and a second section which extends according to a second direction inclined relative to the first transverse direction;
the first section of the plate includes a first guide element, and the second section of the plate includes a second guide element;
the receptacle is formed by several axial wall portions which are realized in one piece with the plate;
the at least one spacer presents in the form of a small wall which is realized in one piece with the plate;
the first section includes two small walls on either side of the first guide element, and the second section includes two small walls on either side of the second guide element.
The present disclosure also proposes a vehicle including a crossmember and a bumper according to any one of the preceding features, the plate being arranged between the rear face of the bumper wall and the front face of the crossmember.

### BRIEF DESCRIPTION OF THE DRAWINGS

The present disclosure will appear more clearly upon reading the description that follows, given solely by way of a non-limiting example, and made with reference to the drawings in which:

FIG. 1 is a longitudinal axial sectional view according to the plane I-I which schematically represents a part of the front or rear face of a vehicle equipped with a bumper fitted with a sensor support in accordance with the teachings of the present disclosure;

FIG. 2 is a transverse axial sectional view according to the plane II-II which schematically represents the part of the front or rear face of the vehicle of FIG. 1;

FIG. 3 is a perspective view which represents the sensor support equipping the bumper of FIG. 1; and

FIG. 4 is a top view, according to the direction of the arrow F1 of FIG. 3, which represents the sensor support equipping the bumper of FIG. 1.

### DETAILED DESCRIPTION

In the remainder of the description, identical or similar elements will in some cases be designated by the same reference numerals.

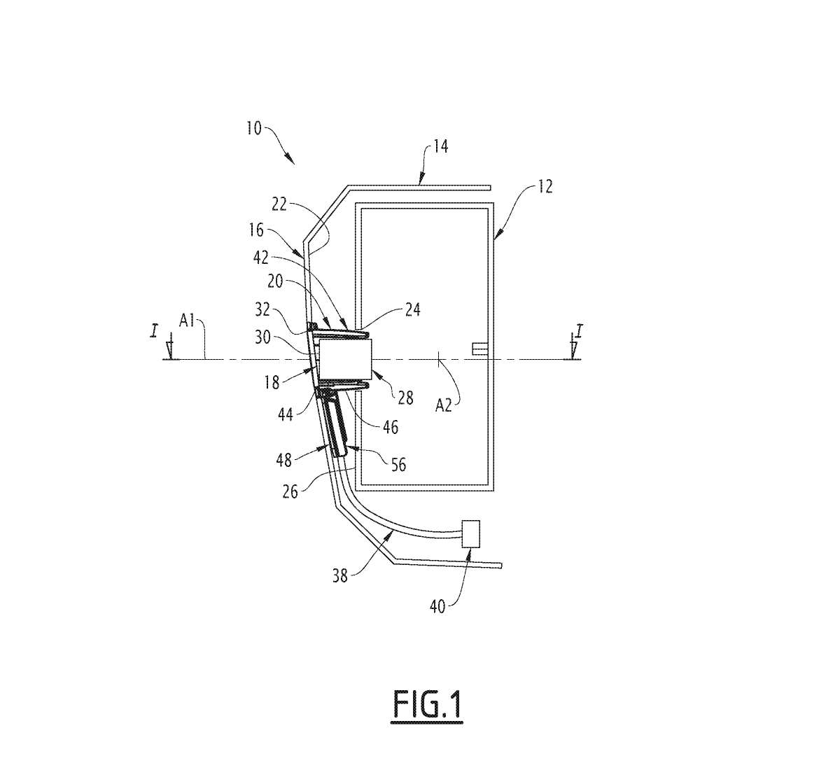

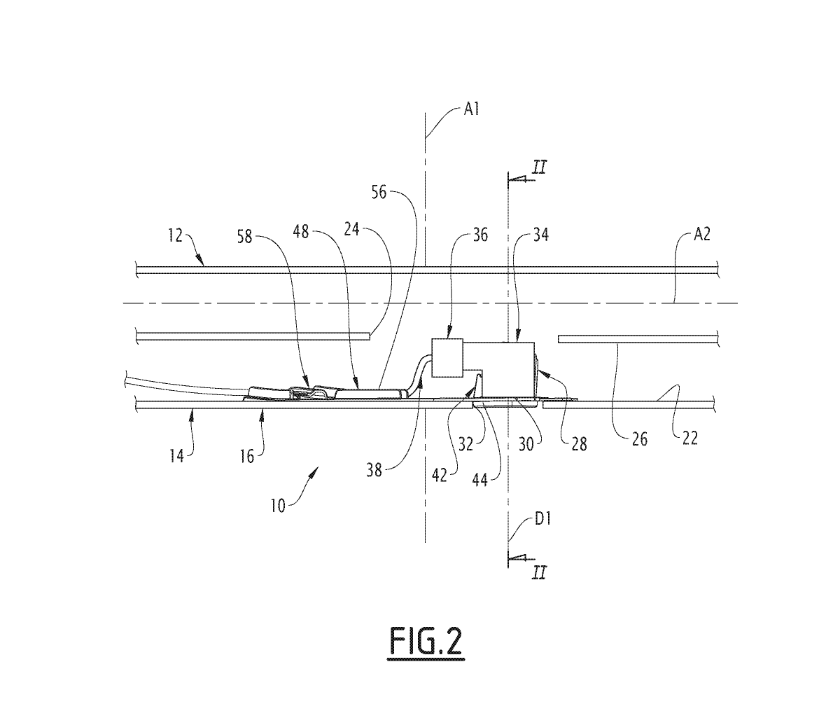

In FIGS. 1 and 2, a part of a vehicle 10 is represented, for example a part of the front or rear end of the vehicle 10.

As a non-limiting example, a direction from rear toward the front will be used, according to a longitudinal axial direction A1, which corresponds to an orientation from right to left when considering FIG. 1.

The vehicle 10 includes a crossmember 12 which extends according to a transverse direction A2. The crossmember 12 is a fixed structural piece belonging to the chassis of the vehicle 10.

According to the embodiment represented, the crossmember 12 presents the shape of a closed metal section realized by a cold rolling method, referred to in English by the expression “roll forming”.

The vehicle 10 includes a bumper 14 which forms a piece of the trim notably allowing to conceal the crossmember 12.

The bumper 14 includes a bumper wall 16, which is positioned in front of the crossmember 12, and a sensor 18 which is mounted on a sensor support 20, on a rear face 22 of the bumper wall 16.

According to the embodiment represented, the crossmember 12 includes a cut-out 24 in its front face 26 which allows the passage of the sensor 18, as will be explained below.

The sensor 18 includes a main body 28, here cylindrical in shape, which extends according to the longitudinal direction A1, and a detection face 30 at its front end.

The general detection direction D1 of the sensor 18 is here parallel to the longitudinal direction A1 and it passes through an opening 32 arranged in the bumper wall 16.

According to the embodiment represented, the sensor 18 is fitted with a connection member 34 complementary to a first connector 36 equipping a first end of a connection cable 38.

The connection member 34 is here offset to the side of the main body 28 in such a manner that the connection direction with the first connector 36 is transverse to A2 and in such a manner as to allow the connection cable 38 to depart leave on the side of the sensor 18.

The connection cable 38 can be formed by a harness of several cables.

The connection cable 38 includes, at a second end, a second connector 40 which allows the connection cable 38 to be plugged in and the sensor 18 to be connected to an electronic control unit (not represented) of the vehicle 10.

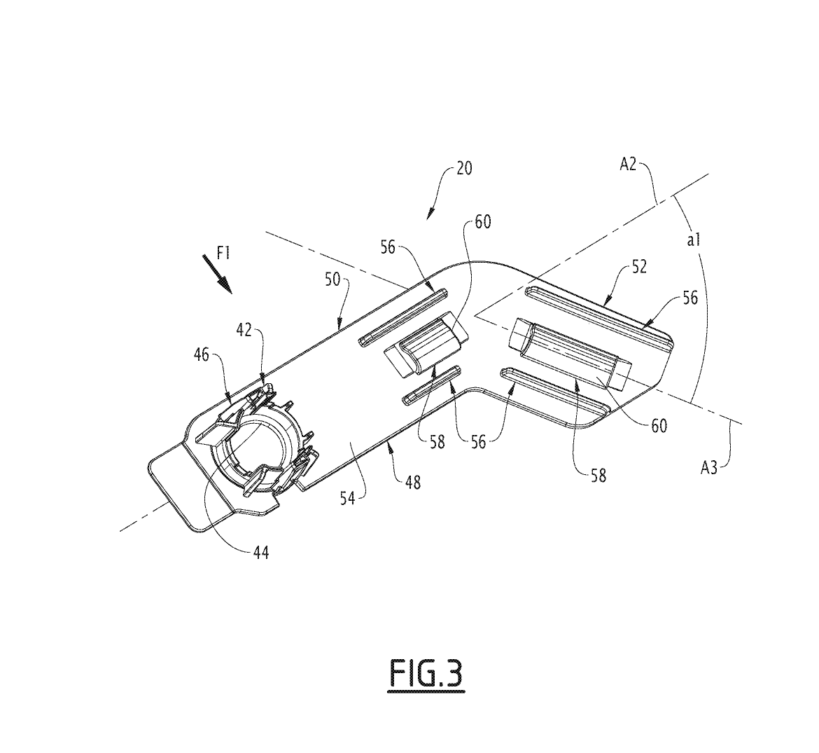

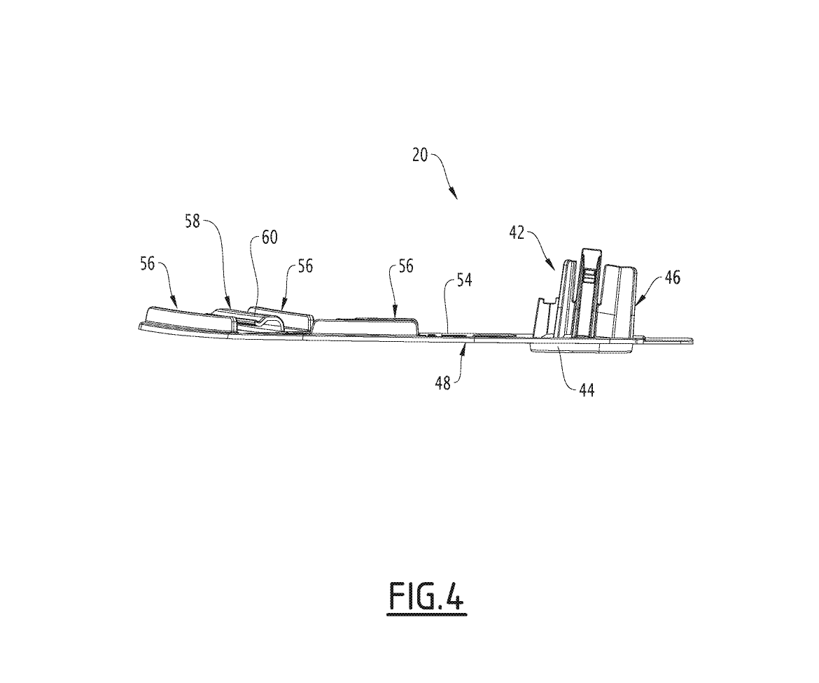

The sensor support 20 is now described in more detail, considering notably FIGS. 3 and 4.

The sensor support 20 includes a receptacle 42 that is provided to receive the main body 28 of the sensor 18. The receptacle 42 includes, at the front, an annular bead 44 which is received in the opening 32 and, at the rear, several axial wall portions 46 that serve to hold the sensor 18 transversely and longitudinally.

Advantageously, the sensor support 20 includes a plate 48 which is fixed against the rear face 22 of the bumper wall 16. The plate 48 generally has the shape of a sheet extending here according to a substantially transverse plane and orthogonal to the longitudinal direction A1 and/or to the detection direction D1. The plate 48 is therefore arranged between the rear face 22 of the bumper wall 16 and the front face 26 of the crossmember 12.

According to the embodiment represented, the plate 48 includes a first section 50, on the side of the receptacle 42, which extends according to the transverse direction A2, and a second section 52, on the side opposite the receptacle 42, which extends according to an inclined direction A3 relative to the transverse direction A2.

The inclined direction A3 describes an angle a1 between 30 and 60 degrees, preferably about 45 degrees, relative to the transverse direction A2.

The plate 48 is fitted, on its rear face 54, with several spacers 56 provided to be interposed longitudinally between the rear face 22 of the bumper wall 16 and the front face 26 of the crossmember 12, in such a manner as to protect the connection cable 38 against crushing between the bumper wall 16 and the front face 26 of the crossmember 12, in the event of a front impact against the bumper wall 16.

The spacers 56 here, present in the shape of small walls which are realized in one piece with the plate 48. These small walls have a longitudinal thickness sufficient to protect the connection cable 38 in the event of an impact on the front face of the bumper wall 16, in other words, when the bumper wall 16 deforms toward the front face 26 of the crossmember 12. They have, for example, a longitudinal thickness substantially equal to the diameter of the connection cable 38, or of the cable harness.

Advantageously, the plate 48 includes guide elements 58 able to retain the connection cable 38 against the plate 48.

Each guide element 58 here, presents in the shape of an elastic tab 60 which is arranged on the rear face 54 of the plate 48 and which is configured to press the connection cable 38 against the rear face 54 of the plate 48.

Each elastic tab 60 here has a hook-shaped profile and has sufficient flexibility, at its connection with the plate 48, to deform elastically during insertion of the connection cable 38 between the elastic tab 60 and the rear face 54 of the plate 48.

Preferably, each guide element 58 is realized in one piece with the plate 48.

According to the embodiment represented, the first section 50 of the plate 48 includes a first guide element 58 and the second section 52 of the plate 48 includes a second guide element 58.

The first section 50 here includes two small walls, on either side of the first guide element, and the second section 52 includes two small walls on either side of the second guide element 58.

Advantageously, the sensor support 20 is entirely realized in one piece, for example by molding in plastic material. Of course, the selected material and manufacturing technology must allow to realize the spacers 56 able to withstand the compression forces due to small impacts on the bumper 14, in such a manner as to ensure sufficient protection of the connection cable 38.

A method for assembling the bumper 14 according to the present disclosure is now described.

During a first step, the sensor 18 is equipped with the connection cable 38. For this purpose, the first connector 36 is plugged onto the connection member 34 of the sensor 18.

During a second step, the sensor 18 is mounted in the receptacle 42 of the sensor support 20 by inserting the main body 28 of the sensor 18 into the receptacle 42. The axial wall portions 46 can include elastic elements such as flexible blades that allow an elastic snap fitting of the sensor 18 into the receptacle 42 and which allow to retain the sensor 18 in the receptacle.

According to an alternative embodiment, the sensor 20 can be equipped with the connection cable 38 after it is mounted in the sensor support 20.

During a third step, the connection cable 38 is passed through the guide elements 58 so that the connection cable 38 follows the transverse direction A2 along the first section 50 of the plate 48, then the inclined direction A3 along the second section 52 of the plate 48.

During a fourth step, the sensor support 20, equipped with the sensor 18 and the connection cable 38, is mounted on the rear face 22 of the bumper wall 16, the annular bead 44 of the receptacle 42 being engaged in the opening 32.

The sensor support 20 can be fixed to the bumper wall 16 by any appropriate means, for example by bonding and/or elastic snap-fitting.

During a fifth step, the bumper 14 is mounted on the corresponding face of the vehicle 10, in such a manner that the bumper wall 16 is at least partly in front of the crossmember 12, and in such a manner that the sensor 18 is partly received inside the crossmember 12 through the cut-out 24.

The cut-out 24, for example, oblong in shape according to the transverse direction A2, allows to provide sufficient space to partly receive the sensor 18 and the first connector 36, which project on the rear face 54 of the plate 48.

The cut-out 24 also allows , during a small front impact on the bumper 14, to allow the sensor 18 to pass without it being compressed between the bumper wall 16 and the crossmember 12. Indeed, during a front impact, deformation of the bumper wall 16 rearward causes the sensor 18 to move toward the rear. The cut-out 24 therefore allows to avoid crushing the sensor 18, which could damage it.

During a sixth step, the connection cable 38 is connected to an electrical harness of the vehicle 10, which allows to ensure the electrical power supply to the sensor 18 and the transmission of the detection signals to the electronic control unit.

The present disclosure has been described here for fixing a single sensor 18 on a single sensor support 20 mounted on the bumper wall 16.

Of course, the bumper 14 can be equipped with several sensors 18 mounted in several sensor supports 20. The sensor supports 20 can be distributed transversely along the bumper wall 16 which includes several openings 32 associated with several sensors 18. The crossmember 12 can also include several cut-outs 24 associated with the different sensors 18.

Any feature described above for one embodiment or alternative is applicable to the other embodiments and alternatives, insofar as it is technically possible.

What is claimed is:

1. A vehicle bumper comprising:
a bumper wall provided to be positioned in front of a crossmember of a vehicle; and
at least one sensor mounted on a sensor support that is fixed on a rear face of the bumper wall,
wherein the sensor support comprises a receptacle receiving the at least one sensor such that a detection direction of the at least one sensor passes through an opening arranged in the bumper wall, the at least one sensor configured to connect to a connection cable,
wherein the sensor support comprises a plate on the rear face of the bumper wall, the plate being fitted, on its rear face, with at least one spacer interposed between the rear face of the bumper wall and a front face of the crossmember to protect the connection cable against crushing between the bumper wall and the front face of the crossmember, in an event of a front impact against the bumper wall,
wherein the plate comprises at least one guide element configured to to retain the connection cable against the plate,
wherein the plate comprises a first section which extends according to a first direction transverse to a main detection axis of the at least one sensor, and a second section which extends according to a second direction inclined relative to the first direction, and
wherein the first section of the plate comprises a first guide element, and the second section of the plate comprises a second guide element.

2. The vehicle bumper according to claim 1, wherein the plate extends generally in a plane substantially orthogonal to the detection direction of the at least one sensor.

3. The vehicle bumper according to claim 1, wherein said at least one guide element comprises an elastic tab which is arranged on the rear face of the plate, the at least one guide element which is configured to press the connection cable against the rear face of the plate.

4. The vehicle bumper according to claim 1, wherein the at least one guide element is made in one piece with the plate.

5. The vehicle bumper according to claim 1, wherein the receptacle is formed by several axial wall sections which are realized in one piece with the plate.

6. The vehicle bumper according to claim 1, wherein the at least one spacer is a wall which is realized in one piece with the plate.

7. The vehicle bumper according to claim 6, wherein the first section comprises two walls on either side of the first guide element, and the second section comprises two walls on either side of the second guide element.

8. A vehicle comprises a crossmember and the vehicle bumper according to claim 1, the plate being arranged between the rear face of the bumper wall and the front face of the crossmember.
